(19) United States
(12) Patent Application Publication
(10) Pub. No.: US 2012/0265955 A1
(43) Pub. Date: Oct. 18, 2012

(54) STORAGE CONTROL APPARATUS FOR COPYING DATA BETWEEN LOGICAL VOLUMES, STORAGE SYSTEM COMPRISING THIS STORAGE CONTROL APPARATUS, AND STORAGE CONTROL METHOD

(75) Inventors: Sou Kawabe, Odawara (JP); Dai Taninaka, Odawara (JP)

(73) Assignee: HITACHI, LTD., Tokyo (JP)

(21) Appl. No.: 13/125,201

(22) PCT Filed: Apr. 12, 2011
(86) PCT No.: PCT/JP2011/002167

§ 371 Date: Apr. 20, 2011

(51) Int. Cl. G06F 12/16

(52) U.S. Cl. 711/162; 711/E12.103

(57) ABSTRACT

A storage control apparatus comprises a virtualization control part in addition to a copy control part determining whether or not a PVOL (a copy-source VOL) attribute set and a SVOL (a copy-destination VOL) attribute set are the same and carrying out a data copy between VOLs in a case where the result of this determination is affirmative. The virtualization control part creates either a virtual PVOL which is a VOL obtained by virtualizing the PVOL and which comprises the SVOL attribute set, or a virtual SVOL which is a VOL obtained by virtualizing the SVOL and which comprises the PVOL attribute set. As a result, either the VOL attribute set of the virtual PVOL and the SVOL attribute set become the same, or the PVOL attribute set and the VOL attribute set of the virtual SVOL become the same, and the copy control part can thereby carry out a copy between VOLs.

### DESCRIPTION

1. Technical Field

The present invention relates to copying data between logical volumes.

2. Background Art

For example, Patent Literature 1 discloses technology related to copying data between logical volumes (hereinafter, VOL).

### CITATION LIST

### Patent Literature

PTL 1: Japanese Patent Application Laid-open No. 2010-49634

### SUMMARY OF INVENTION

### Technical Problem

In the following explanation, a copy-source VOL will be called a “PVOL”, and a VOL attribute set of the PVOL will be called a “PVOL attribute set”. Alternatively, a copy-destination VOL will be called a “SVOL”, and a VOL attribute set of the SVOL will be called a “SVOL attribute set”.

However, a data copy between VOLs is executed by a copy control part of a storage control apparatus. The thinking is that the PVOL attribute set and the SVOL attribute set should be the same. A copy control part configured in accordance with this thinking comprises a function for determining whether or not the PVOL attribute set and the SVOL attribute set are the same, and a function for carrying out a copy in a case where the result of this determination is affirmative. In general, the copy control part is realized in accordance with a controller (for example, a processor) for executing a copy control program. A VOL attribute set comprises one or more VOL attributes, which are compared at the time of the above-mentioned determination by the copy control part. These VOL attributes, for example, include a capacity, a data format, and the execution or non-execution of a predetermined type of function of the storage control apparatus.

According to the above-mentioned copy control part, the VOL attribute set must comprise a VOL pair (a pair comprising a PVOL and a SVOL) of the same VOLs in order for a data copy between VOLs to be carried out.

Furthermore, in a case where an old type storage control apparatus (hereinafter, old apparatus) is to be replaced with a new type storage control apparatus (hereinafter, new apparatus), data inside the VOL managed by the old apparatus will be copied to the VOL managed by the new apparatus. At this time as well, the PVOL attribute set must be the same as the SVOL attribute set. However, the functions and storage device type of the new apparatus differ from the functions and storage device type of the old apparatus. In accordance with this, in order to copy the data inside the VOL managed by the old apparatus to the VOL managed by the new apparatus, an external apparatus (for example, a host computer or a management computer) of the storage control apparatus must read the data from the old apparatus-managed VOL to the new apparatus-managed VOL. That is, data must be copied by way of an external apparatus.

One method for improving this might be a method that significantly changes the logic of the copy control part. According to this method, a change that accords with how the PVOL attribute set and the SVOL attribute set differ and what type of processing is to be carried out is deemed necessary.

However, as much as possible it is preferable that the logic of the copy control part not be changed. This is because the logic of the copy control part has been established in accordance with the thinking that the PVOL attribute set should be the same as the SVOL attribute set, and because significantly changing the logic of the copy control part lowers the versatility of the copy control part.

Accordingly, an object of the present invention is to enable data copy between VOLs to be carried out by a copy control part based on logic, which, even in a case where the PVOL attribute set and the SVOL attribute set differ, determines whether or not the PVOL attribute set and the SVOL attribute set are the same, and carries out a data copy between VOLs when the result of this determination is affirmative.

### Solution to Problem

The storage control apparatus comprises a virtualization control part in addition to a copy control part, which constitutes logic for determining whether or not the PVOL attribute set and the SVOL attribute set are the same, and carrying out a data copy between VOLs when the result of this determination is affirmative. The virtualization control part creates either a virtual PVOL, which is a VOL obtained by virtualizing a PVOL and which comprises a SVOL attribute set, or a virtual SVOL, which is a VOL obtained by virtualizing a SVOL and which comprises a PVOL attribute set. As a result, either the VOL attribute set of the virtual PVOL and the SVOL attribute set become the same, or the PVOL attribute set and the VOL attribute set of the virtual SVOL become the same, and the copy control part can thereby either copy data from the virtual PVOL to the SVOL, or copy data from the PVOL to the virtual SVOL.

### BRIEF DESCRIPTION OF DRAWINGS

FIG. 1 shows an example of an overview of a first example of the present invention.

FIG. 2 shows an example of the configuration of a storage system related to the first example of the present invention.

FIG. 3A shows an example of management information and computer programs of a storage apparatus 103. FIG. 3B shows an example of the relationship between PDEVs 105 and LDEVs 313.

FIG. 4A shows an example of the configuration of a LDEV management table 303. FIG. 4B shows an example of the configuration of a virtualization management table 301. FIG. 4C shows an example of the configuration of a copy management table 302.

FIG. 5 shows an example of the flow of processing carried out in the first example.

FIG. 6A shows an example of one portion of the LDEV management table 303.

FIG. 6B shows an example of a row of the virtualization management table 301 in which is recorded information related to a virtual PVOL. FIG. 6C shows an example of a row of the virtualization management table 301 in which is recorded information related to a virtual SVOL. FIG. 6D shows an example of a portion of the copy management table 302.

FIG. 7 shows an example of the flow of processing carried out by a second example of the present invention.

FIG. 8A shows an example of a screen displayed in S707 of FIG. 7. FIG. 8B shows an example of a screen displayed in S712 of FIG. 7.

FIG. 9 shows an example of the flow of processing carried out by a copy control program 304 related to a third example.

FIG. 10A shows the selection of which of a PVOL or a SVOL is to be virtualized in a fourth example. FIG. 10B shows an example of a case in which a virtual PVOL is to be created. FIG. 10C shows an example of a case in which a virtual SVOL is to be created.

### DESCRIPTION OF EMBODIMENTS

A number of examples of the present invention will be explained below.

In the following explanation, various types of information may be explained using the expression “xxx table”, but the various information may also be expressed using a data structure other than a table. To show that the various information is not dependent on the data structure, “xxx table” can be called “xxx information”.

Furthermore, in the following explanation, a number is used to identify an element (for example, a pair, a LDEV (logical device) of a logical volume), but another type of information (for example, an identifier or a name) may be used either instead of or in addition to the number as identification information. Hereinafter, the word “number” may be expressed using the symbol “#”.

Furthermore, in the following explanation, there may be cases where the processing is explained having a “program” as the subject, but since the stipulated processing may be performed in accordance with a program being executed by a processor (for example, a CPU (Central Processing Unit)) included in a controller while using a storage resource (for example, a memory) and/or a communication interface device (for example, a communication port) as needed, the processor may also be used as the subject of the processing. Processing explained using the program as the subject may be processing carried out by the controller. Furthermore, the controller may be the processor itself, or may comprise, either instead of or in addition to the processor, a hardware circuit that carries out either part or all of the processing performed by the processor. A computer program may be installed in the storage control apparatus from a program source. The program source, for example, may be either a program delivery server or a computer-readable storage medium.

Furthermore, the management computer may be configured from one or more computers. The management computer comprises an I/O (Input/Output) device, a storage resource, and a controller comprising a processor that is coupled to these elements. The I/O device, for example, may be a display device, a microphone, a speaker, a keyboard, or a pointing device, but may also be a device other than these, for example, a communication interface device (for example, either a serial interface or a Ethernet interface (Ethernet is a registered trademark)). A computer (hereinafter, the display computer) comprising an I/O device (for example, either a display device or a keyboard and a pointing device) may be coupled to the communication interface device. The management computer may either send display information to the display computer, or receive information (input information) inputted via the I/O device (the input device) from the display computer. This enables display information to be displayed on the display computer, and enables the management computer to receive input information using the I/O device. In each of the examples hereinbelow, the management computer will be expressed as the “maintenance terminal”.

The storage control apparatus may be a storage apparatus, which comprises one or more physical storage devices (hereinafter, PDEV) that form the basis of a VOL, may be an apparatus, which is stored in this storage apparatus, or may be a server apparatus or an intelligent switching apparatus, which is coupled to one or more PDEVs that form the basis of a VOL. In the following embodiment, it is supposed that the storage control apparatus is a storage apparatus.

Furthermore, in the following explanation, a logical volume will be called a “VOL”, a copy-source VOL will be called a “PVOL”, and a copy-destination VOL will be called a “SVOL”. Also, a VOL attribute set of the PVOL will be called the “PVOL attribute set”, and the VOL attribute set of the SVOL will be called the “SVOL attribute set”. The PVOL and the SVOL may be on a single storage control apparatus, or may be on two different storage control apparatuses. A RAID (Redundant Array of Independent (or Inexpensive) Disks) group may be configured using one or more PDEVs, and a RAID group-based VOL may be prepared.

Furthermore, the type of either of the PVOL or the SVOL need not be limited. For example, both the PVOL and the SVOL may be actual VOLs based on one or more PDEVs, may be virtual VOLs (VOLs virtualized using a storage virtualization technique), which are virtualized VOLs provided by an external storage apparatus, or may be virtualized VOLs in accordance Thin Provisioning. In the respective examples that follow, both the PVOL and the SVOL will be actual VOLs based on one or more PDEVs.

Furthermore, the type of the PDEV need not be limited. For example, the PDEV may be a HDD (Hard Disk Drive) or may be a flash memory.

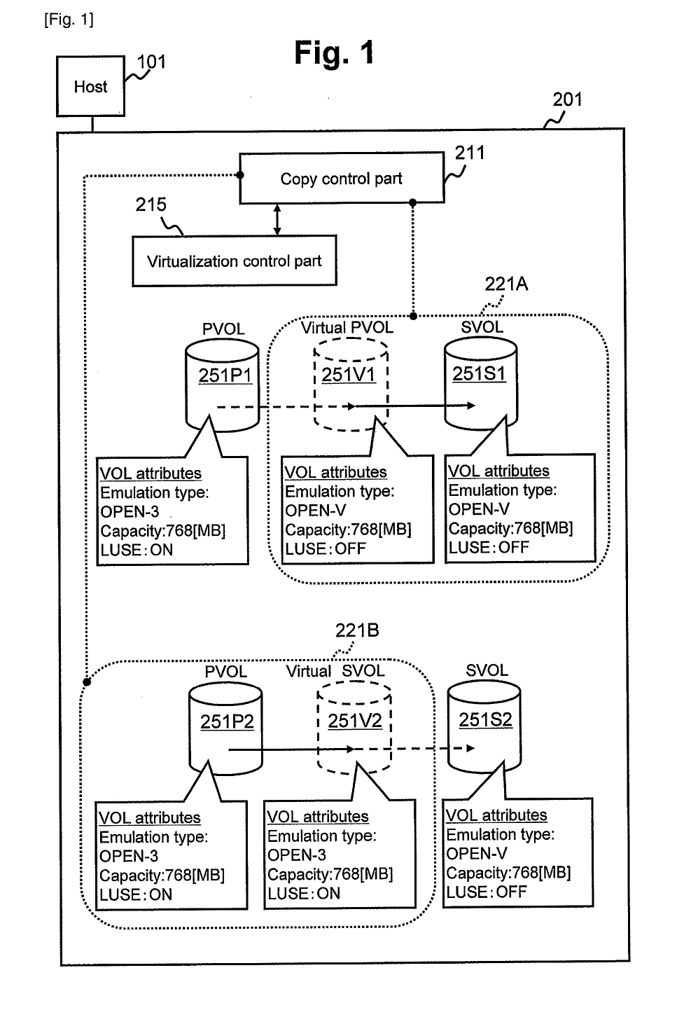

Furthermore, in the following explanation, in a case where no distinction is made between elements of the same type (for example, VOLs, PVOLs, SVOLs, or virtual VOLs), only that part of the reference sign shared in common may be used. For example, in FIG. 1, in a case where no distinction is made between the PVOL 251P1 and the SVOL 251S1, these may be called “VOL 251”, and in a case where no distinction is made between the PVOL 251P1 and the PVOL 251P2, these may be called “PVOL 251P”.

### EXAMPLE 1

FIG. 1 shows an example of an overview of a first example of the present invention.

There is a storage system 201. The storage system 201 comprises one or more storage apparatuses. At least one of the one or more storage apparatuses is coupled to a host 101. The host 101 may be a single computer, may be a system comprising one or more computers, or may be another storage system.

The storage system 201 comprises multiple VOLs 251. The multiple VOLs 251 comprise at least one PVOL 251P and at least one SVOL 251S.

At least one of the one or more storage apparatuses comprises a virtualization control part 215 in addition to a copy control part 211, which constitutes logic for determining whether or not the PVOL attribute set and the SVOL attribute set are the same, and carrying out a data copy between VOLs in a case where the result of this determination is affirmative.

A VOL attribute set comprises one or more VOL attributes. In FIG. 1, emulation type, capacity, and LUSE yes/no (ON, OFF) are shown as examples of VOL attributes. The “emulation type” is the type of format for the data arrangement in the VOL. The “capacity” is the capacity of the VOL. LUSE signifies the VOL expansion function. Therefore, the presence or absence of LUSE signifies whether or not a VOL is a logical concatenation of multiple VOLs (more correctly, LDEVs, which will be described further below). A LUSE (ON) VOL is a VOL obtained by concatenating multiple LDEV, and a LUSE (OFF) VOL is a VOL comprising a single LDEV. For example, emulation type and LUSE ON/OFF are the VOL attributes related to the arrangement of data inside the VOL (hereinafter, a data arrangement attribute). The data arrangement attribute may also be another VOL attribute either instead of or in addition to at least one of the emulation type and the LUSE ON/OFF.

The virtualization control part 255 creates a virtual PVOL 251V, which is a VOL obtained by virtualizing the one of the PVOL 251P and the SVOL 251S and comprises the VOL attribute set of the other of the PVOL 251P and the SVOL 251S.

For example, the virtualization control part 255 creates a virtual PVOL 251V1, which is a VOL obtained by virtualizing the PVOL 251P1 and comprises the VOL attribute set of the SVOL 251S1. As a result of this, although the VOL attribute sets of the PVOL 251P1 and the SVOL 251S1 are different, the VOL attribute set of the virtual PVOL 251V1 is the same as the VOL attribute set of the SVOL 251S1. The VOL attribute set of the virtual PVOL 251V1 is the same as the VOL attribute set of the SVOL 251S1. Therefore, the copy control part 211 is able to copy data from the PVOL 251P1 to the SVOL 251S1 by copying data from the virtual PVOL 251V1 to the SVOL 251S1 (Refer to the area inside dotted line 221A).

Furthermore, for example, the virtualization control part 255 creates a virtual SVOL 251V2, which is a VOL obtained by virtualizing the SVOL 251S2 and comprises the VOL attribute set of the PVOL 251P2. As a result of this, although the VOL attribute sets of the PVOL 251P2 and the SVOL 251S2 are different, the VOL attribute set of the virtual SVOL 251V2 is the same as the VOL attribute set of the PVOL 251P2. For this reason, the VOL attribute set of the PVOL 251P2 is the same as the VOL attribute set of the virtual SVOL 251V2. Therefore, the copy control part 211 is able to copy data from the PVOL 251P2 to the SVOL 251S2 by copying the data from the PVOL 251P2 to the virtual SVOL 251V2 (Refer to the area inside dotted line 221B).

Furthermore, in a data copy between VOLs, the copy control part 211 copies data from a copy-source area (for example, an area from among multiple areas (for example, blocks) comprising a VOL) to a copy-destination area, and the address of the copy-source area and the address of the copy-destination area are the same at this time. However, according to the example of FIG. 1, the data arrangement attribute (for example, the emulation type) of the PVOL 251P1 differs from the data arrangement attribute of the virtual PVOL 251V1, and the data arrangement attribute of the virtual SVOL 251V2 differs from the data arrangement attribute of the SVOL 251S2. For this reason, the copy-target data will not be able to be read correctly in the data copy between VOLs unless the address of the copy-source area in the virtual PVOL 251V1 is converted to the address of the copy-source area in the PVOL 251P1. Similarly, the copy-target data will not be able to be written correctly in the data copy between VOLs unless the address of the copy-destination area in the virtual SVOL 251V2 is converted to the address of the copy-destination area in the SVOL 251S2.

Consequently, the virtualization control part 215 is able to perform an address conversion process.

For example, the following processing is carried out in the data copy denoted by reference sign 221A. That is, the copy control part 211 inputs the original address of the copy-source area to the virtualization control part 215. The virtualization control part 215 converts the inputted original address and outputs the post-conversion address to the copy control part 211. Specifically, for example, the virtualization control part 215 determines the address based on the inputted original address and the difference between the data arrangement attribute of the PVOL 251P1 and the data arrangement attribute of the virtual PVOL 251V1, and outputs the determined address to the copy control part 211. The copy control part 211 reads the data from the copy-source area (the area in the PVOL 251P1) that conforms to the outputted address, and writes the read data to the copy-destination area (the area in the SVOL 251S1) that conforms to the same address as the original address.

Also, for example, the following processing is carried out in the data copy denoted by the reference sign 221B. That is, the copy control part 211 inputs the original address of the copy-destination area to the virtualization control part 215. The virtualization control part 215 converts the inputted original address and outputs the post-conversion address to the copy control part 211. Specifically, for example, the virtualization control part 215 determines the address based on the inputted original address, and the difference between the data arrangement attribute of the SVOL 251S2 and the data arrangement attribute of the virtual SVOL 251V2, and outputs the determined address to the copy control part 211. The copy control part 211 reads the data from the copy-source area (the area in the PVOL 251P2) that conforms to the same address as the original address, and writes the read data to the copy-destination area (the area in the SVOL 251S2) that conforms to the outputted address.

At least one of the PVOL 251P and the SVOL 251S may be provided to the host 101.

Furthermore, the virtual PVOL 251V1 may be provided to the host 101 instead of the

PVOL 251P1. For example, a VOL provision part (not shown in the drawing), which is a function for providing a VOL to the host 101, may provide the virtual PVOL 251V1 to the host 101 rather than the PVOL 251P1 in a case where the VOL attribute set of the virtual PVOL 251V1 is better than the VOL attribute set of the PVOL 251P1. The provision of the virtual PVOL 251V1, for example, may be carried out in response to a query (for example, and Inquiry request) from the host 101. Furthermore, a first VOL attribute set is better than a second VOL attribute set signifies that the first VOL attribute set comprises more good VOL attributes than the second VOL attribute set. A “good VOL attribute” is a VOL attribute that conforms to either a new model (a storage apparatus model) or a new function (for example, an upgraded computer program in the storage apparatus).

Similarly, the virtual SVOL 251V2 may be provided to the host 101 instead of the SVOL 251S2. For example, the above-mentioned VOL provision part may provide the virtual SVOL 251V2 to the host 101 rather than the SVOL 251S2 in a case where the VOL attribute set of the virtual SVOL 251V2 is better than the VOL attribute set of the SVOL 251S2. The provision of the virtual SVOL 251V2, for example, may be carried out in response to a query (for example, and Inquiry request) from the host 101.

The copy control part 211 may be a function that is realized in accordance with a copy control program being executed by the processor included in the controller. Similarly, the virtualization control part 215 may be a function that is realized in accordance with a virtualization control program being executed by the processor included in the controller. A portion of the processing carried out by the copy control part 211 and the virtualization control part 215 may be performed by a hardware circuit.

The storage system related to this example will be explained in detail below by referring to the drawings.

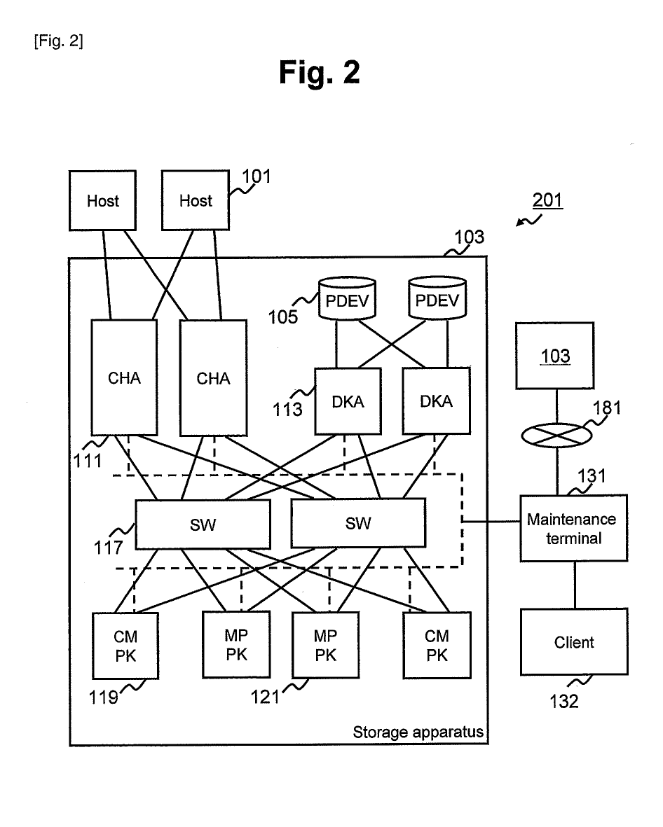

FIG. 2 shows an example of the configuration of the storage system related to a first example of the present invention.

The storage system 201 comprises one or more storage apparatuses 103, and a maintenance terminal 131, which is coupled to the one or more storage apparatuses 103. The maintenance terminal 131, for example, is coupled to the one or more storage apparatuses 103 via a communication network 181. The maintenance terminal 131 may exist in each of the storage apparatuses 103. The maintenance terminal 131 communicates with a client 132. The client 132 is at least one computer, and, for example, comprises man-machine interface devices (specifically, a display device and an input device) as I/O devices.

The storage apparatus 103, for example, comprises one or more PDEVs 105, a backend I/F (a communication interface device) that is coupled to the one or more PDEVs 105, a frontend I/F that is coupled to the host 101, a storage resource, and a controller that is coupled to these elements. According to the example of the configuration shown in FIG. 2, the backend I/F is one or more DKAs (disk adapters) 113, the frontend I/F is one or more CHAs (channel adapters) 111, the storage resource is one or more CMPKs (cache memory packages) 119, and the controller is one or more MPPKs (microprocessor packages) 121. The CHA 111, DKA 113, CMPK 119 and MPPK 121 are coupled to one or more SWs (switches) 117. From the aspect of redundancy, each of the CHA 111, DKA 113, MPPK 121, CMPK 119 and SW 117 exists in multiples, and the number of at least one of these is not limited to the two shown in the drawing, but rather can be more or less than two.

The CHA 111 receives an I/O request (a write request or a read request) comprising I/O-destination information from the host 101, and transfers the received I/O request to any one of the multiple MPPKs 121. The I/O-destination information, for example, comprises a VOL ID (for example, a LUN (Logical Unit Number)), and an address of an area in the VOL (for example, a LBA (Logical Block Address)).

The DKA 113 reads data from the PDEV 105, writes this data to the cache memory (hereinafter, CM) inside the CMPK 119, reads the data from the CM inside the CMPK 119, and writes this data to the PDEV (for example, the PDEV, which is the basis of the VOL that is the data write-destination) 105.

The MPPK 121 is a device comprising either one or multiple MPs (microprocessors). The MP processes an I/O request from the CHA 111.

Each of the elements, i.e., the CHA 111, the DKA 113, the CMPK 119 and the MPPK 121, is able to communicate with the other elements, i.e., the CHA 111, the DKA 113, the CMPK 119 and the MPPK 121, via the SW 117.

The CMPK 119 comprises one or more cache memories (hereinafter CMs). One or more CMs are volatile memory and/or nonvolatile memory. The one or more CMs, in addition to a storage area (hereinafter, the cache area) for temporarily storing data that is input/output to/from the PDEV 105, may also comprise a storage area (hereinafter, the shared area) for storing management information referred to by the MP.

The maintenance terminal 131 is able to communication with at least the MPPK 121 from among the CHA 111, the DKA 113, the CMPK 119 and the MPPK 121. The maintenance terminal 131, for example, can collect information from the CHA111, the DKA 113, the CMPK 119 and the MPPK 121, and can store the collected information. Furthermore, the maintenance terminal 131 can send a request conforming to an instruction from the client 132 to the MPPK 121 of the storage apparatus 103.

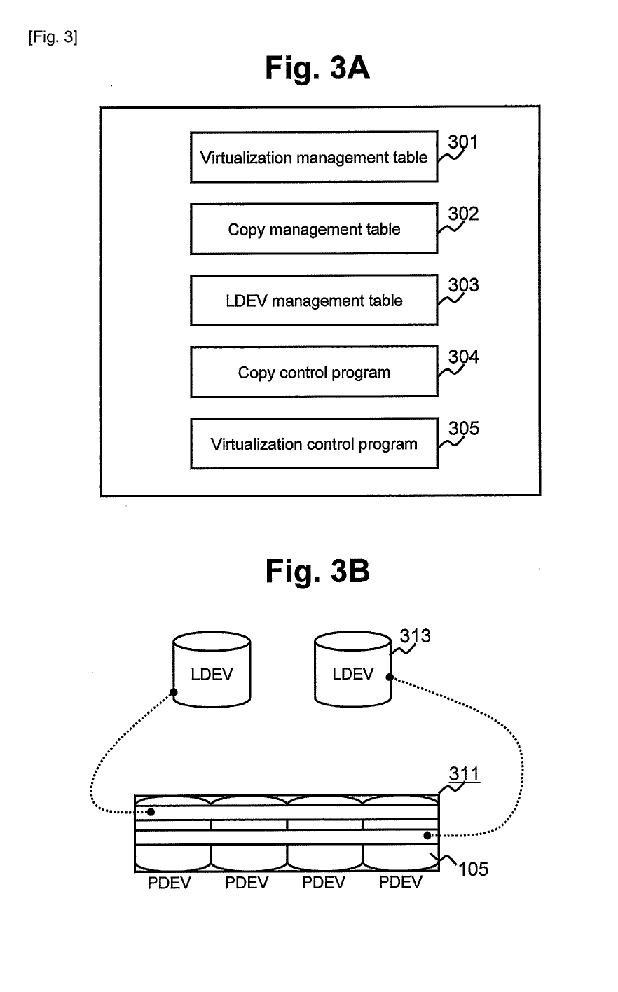

FIG. 3A shows examples of the management information and computer programs of the storage apparatus 103.

The management information, for example, comprises a virtualization management table 301, which comprises information related to a virtual PVOL and/or a virtual SVOL; a copy management table 302, which comprises information related to a VOL pair; and a LDEV management table 303, which comprises information related to a LDEV. As shown in FIG. 3B, the LDEV 313 is a logical storage device based on a RAID group 311. A single VOL may be one LDEV 313 or may be a LDEV group in which multiple LDEVs 313 are concatenated (LUSE “ON”).

As the computer programs, there are a copy control program 304 and a virtualization control program 305. The logic of the copy control program 304 determines whether or not the PVOL attribute set and the SVOL attribute set are the same, and copies data between the VOLs in a case where the result of this determination is affirmative. The virtualization control program 305 creates the virtual PVOL and/or the virtual SVOL described hereinabove.

The tables 301 through 303 and the programs 304 and 305 may reside in the shared area of the CMPK 119, or may reside in a storage resource (a memory) inside the MPPK 121.

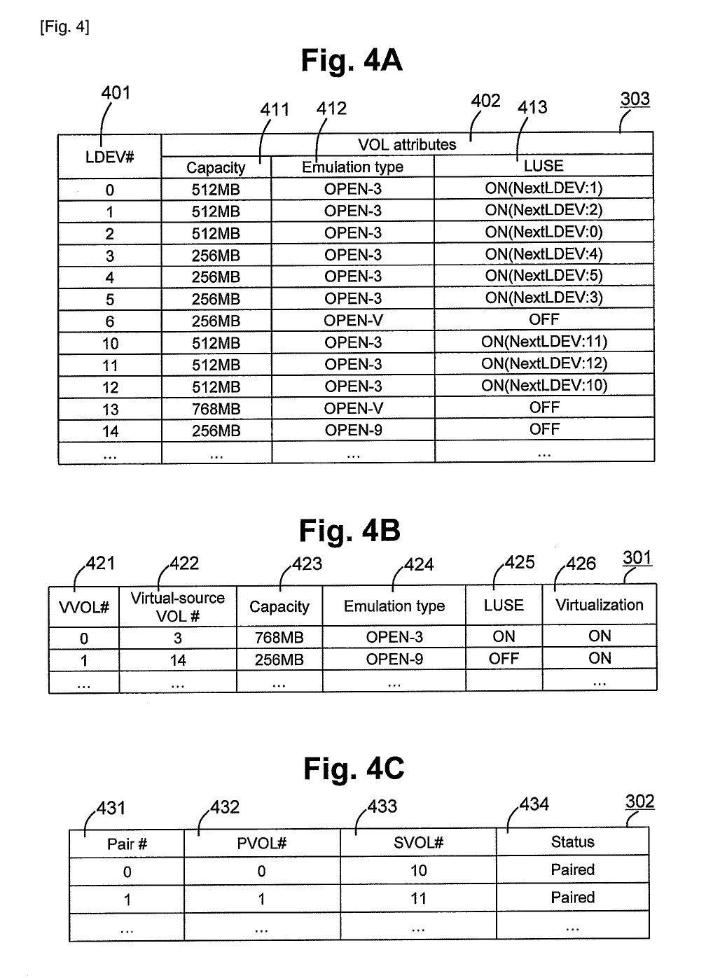

FIG. 4A shows an example of the configuration of the LDEV management table 303.

The LDEV management table 303 comprises the following information for each LDEV:
(*) a LDEV #401, which is the identification number of the LDEV 313; and
(*) VOL attributes 402, which is information denoting the VOL attribute set of the LDEV 313.

In this example, the one or more VOL attributes comprising a VOL attribute set, as described hereinabove, are emulation type, capacity, and LUSE ON/OFF. For this reason, the VOL attributes 402 comprises the following information:
(*) a capacity 411, which is information denoting the capacity of the LDEV 313;
(*) an emulation type 412, which is information denoting the emulation type of the LDEV 313; and
(*) a LUSE 413, which is information denoting the presence or absence of LUSE for the LDEV 313.

In addition to LUSE ON/OFF, the LUSE 413 also comprises the identification number of a concatenation-destination LDEV when LUSE is ON. As a result, it is clear from this table 303 which multiple LDEVs comprise a single VOL. Furthermore, the identification number of the VOL that is comprised from multiple LDEVs may be the identification number of one LDEV (for example, the first LDEV) from among these multiple LDEVs. According to the LUSE function, it is possible to configure a single VOL from multiple LDEVs having the same VOL attribute sets.

The emulation type, for example, includes a type, which is an open volume format and is applicable to a large-capacity VOL; a type, which is an open volume format but cannot be applied to a VOL with a capacity that is equal to or larger than a predetermined capacity; and a type, which is a mainframe volume format.

Furthermore, the one or more VOL attributes comprising the VOL attribute set are not limited to capacity, emulation type, and LUSE ON/OFF, but rather another type of VOL attribute may be used either instead of or in addition to at least one of these types. The other type of VOL attribute, for example, may be at least one of via-CM ON/OFF or VOL sharing ON/OFF. Via-CM “ON” signifies that a write-complete response is sent to the host 101 when write-target data attached to a write request (a write request from the host 101), which specifies a VOL comprising this attribute, is written to the CM. Via-CM “OFF” signifies that a write-complete response is sent to the host 101 when write-target data attached to a write request (a write request from the host 101), which specifies a VOL comprising this attribute, is written to the PDEV 105. VOL sharing “ON” signifies that a VOL corresponding to this attribute can be used by both a mainframe-system host 101 and an open-system host 101. VOL sharing “OFF” signifies that a VOL corresponding to this attribute can only be used by an open-system host 101 and cannot be used by a mainframe-system host 101.

FIG. 4B shows an example of the configuration of the virtualization management table 301.

The virtualization management table 301 comprises the following information for each VOL created by the virtualization control program 305:
(*) a VVOL #421, which is the identification number of the virtual VOL;
(*) a virtual-source VOL #422, which is the identification number of the VOL that constitutes the source of the virtual VOL;
(*) a capacity 423, which is information denoting the capacity, which is one VOL attribute in the VOL attribute set of the virtual VOL;
(*) an emulation type 424, which is information denoting the emulation type, which is one VOL attribute in the VOL attribute set of the virtual VOL;
(*) a LUSE 425, which is information denoting LUSE ON/OFF, which is one VOL attribute in the VOL attribute set of the virtual VOL; and
(*) virtualization 426, which is information denoting whether or not the virtual VOL is valid.

FIG. 4C shows an example of the configuration of the copy management table 302.

The copy management table 302 comprises the following information for each VOL pair:
(*) a pair #431, which is the identification number of a VOL pair;
(*) a PVOL #432, which is the VOL # of the PVOL in the VOL pair;
(*) a SVOL #433, which is the VOL # of the SVOL in the VOL pair; and
(*) a status 434, which is information denoting the status of the VOL pair.

The status 434, for example, is updated as needed (for example, in a case where a data copy between VOLs has been completed) by the copy control part 211.

The processing carried out in this example will be explained below.

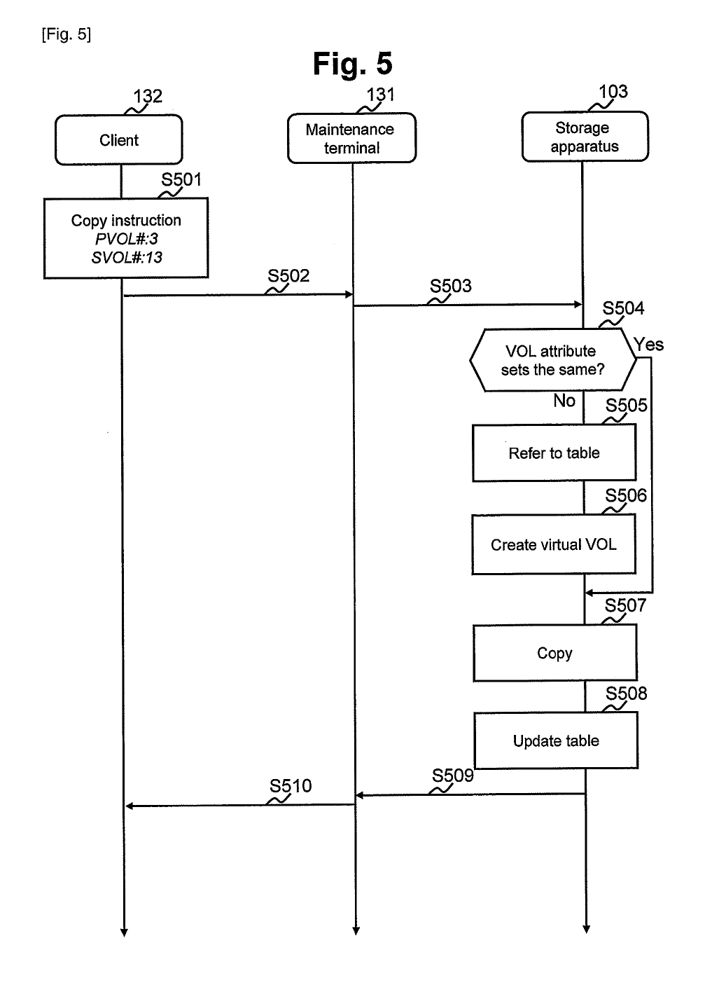

FIG. 5 shows an example of the flow of processing carried out by the first example. Furthermore, in the following explanation, an element AAA having an identification number “m” may be described as “AAA “m””.

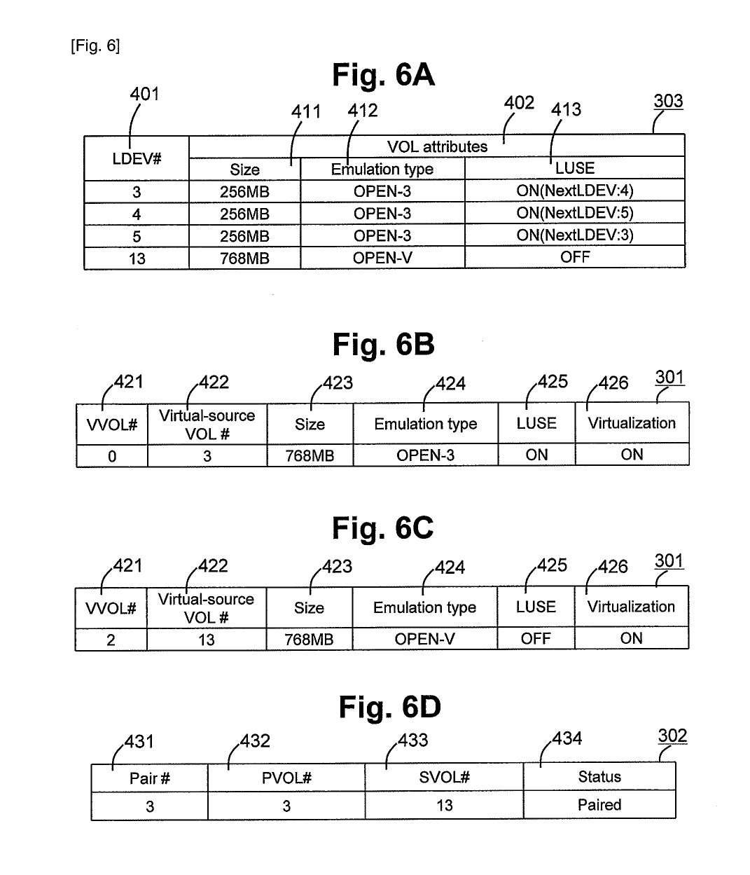

The client 132 receives a copy instruction from the client 132 input device (S501). This copy instruction, for example, comprises a PVOL # and a SVOL # as parameters. It will be supposed here that, for example, a PVOL # of “3” and a SVOL # of “13” are inputted. According to FIG. 6A, PVOL “3” is a VOL comprised from the three LDEVs “3” through “5”, and SVOL “13” is the LDEV “13”.

The maintenance terminal 131 receives the copy instruction comprising the PVOL #“3” and the SVOL #“13” from the client 132 (S502), and sends this instruction to the storage apparatus 103 (S503). The copy instruction is sent to one or more storage apparatuses 103 comprising the PVOL “3” and the SVOL “13”. It will be supposed here that this copy instruction has been sent to one storage apparatus 103.

In the storage apparatus 103, the copy control program 304, based on the LDEV management table 303, determines whether or not the VOL attribute set of the PVOL “3” and the VOL attribute set of the SVOL “13” are the same (S504).

In a case where the result of the determination in S504 is affirmative (S504: Yes), the copy control program 304 copies data from the PVOL “3” to the SVOL “13” (S507). Then, the copy control program 304 updates information (the information in the copy management table 302) related to the VOL pair of the PVOL “3” and the SVOL “13” (refer to FIG. 6D) (S508). In S508, for example, the status 434 is updated. Thereafter, the copy control program 304 sends a completion notification to the maintenance terminal 131, which was the source of the copy instruction (S509), and the maintenance terminal 131 sends this completion notification to the client 132, which was the source of the copy instruction (S510).

In a case where the result of the determination in S504 is negative (S504: No), the copy control program 304 calls the virtualization control program 305.

The virtualization control program 305 refers to the LDEV management table 303 (S505), and creates either a virtual PVOL or a virtual SVOL (S506). In S506, for example, information corresponding to the created virtual VOL is registered in the virtualization management table 301. In a case where a virtual PVOL has been created, “3”, which is the identification number of the PVOL “3”, is registered in the virtualization management table 301 as the virtual-source VOL #422, and information that is the same as the information 411 through 413 corresponding to the SVOL “13” is registered as information 423 through 425 (refer to FIGS. 6A and 6B). Alternatively, in a case where a virtual SVOL has been created, “13”, which is the identification number of the SVOL “13” is registered in the virtualization management table 301 as the virtual-source VOL #422, and information that is the same as the information 411 through 413 corresponding to the PVOL “3” is registered as the information 423 through 425 (refer to FIGS. 6A and 6C).

After S506, S507 through S510 are carried out.

According to the flow of processing shown in this FIG. 5, a virtual VOL is created without the issuing of a query as to whether or not a virtual VOL is to be created.

### EXAMPLE 2

A second example of the present invention will be explained hereinbelow. In so doing, the points of difference with the first example will mainly be explained, and explanations of the points in common with the first example will either be simplified or omitted (This is not limited to the second example; the same will hold true for the third and subsequent examples as well).

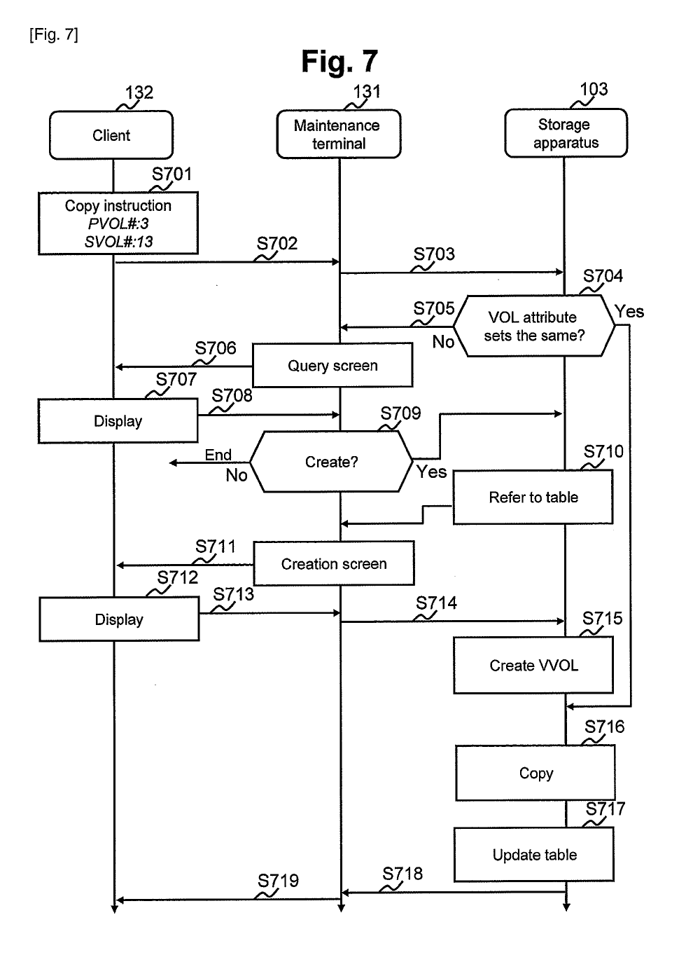

FIG. 7 shows an example of the flow of processing carried out by the second example of the present invention.

The client 132 receives a copy instruction from the client 132 input device (S701). The same as in S501 of FIG. 5, it will be supposed that PVOL “3” and SVOL “13” are specified in this copy instruction.

The same as in S502 and S503 of FIG. 5, the copy instruction is sent to the storage apparatus 103 (S702 and S703).

The copy control program 304, based on the LDEV management table 303, determines whether or not the VOL attribute set of the PVOL “3” is the same as the VOL attribute set of the SVOL “13” (S704).

In a case where the result of the determination of S704 is affirmative (S704: Yes), the same processing as that of S507 through S510 of FIG. 5 is carried out (S716 through S719).

In a case where the result of the determination of S704 is negative (S704: No), the copy control program 304 calls the virtualization control program 305. The virtualization control program 305 sends the maintenance terminal 131 information denoting that the result of the determination of S704 was negative (S705).

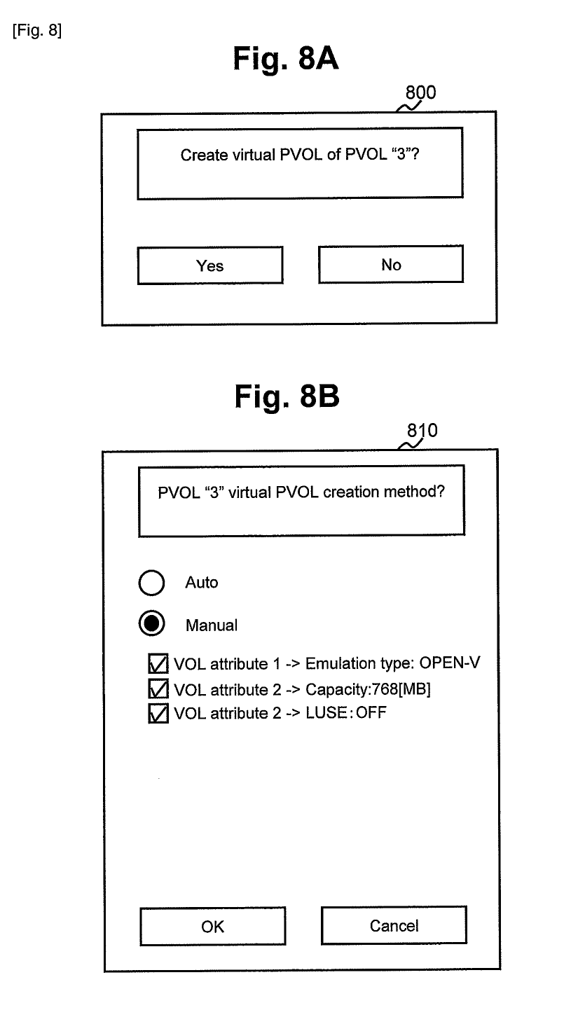

The maintenance terminal 131, upon receiving this information, sends the client 132 query screen display information denoting whether or not a virtual VOL is to be created (S706). It will be supposed here that the query screen queries whether or not a virtual PVOL of PVOL “3” is to be created (refer to Screen 800 shown in FIG. 8A). Furthermore, the query screen may query which of PVOL “3” and SVOL “13” is to be virtualized. In a case where one of PVOL “3” and SVOL “13” cannot be virtualized in accordance with a predetermined condition, the query screen may query as to the virtualization of the other of the PVOL “3” and the SVOL “13”.

The client 132 displays the display information sent in S706 (S707). In accordance with this, for example, the screen 800 shown in FIG. 8A is displayed on the display device of the client 132. The client 132 receives the reply to the query from the client 132 input device, and sends information denoting this reply (reply information).

The maintenance terminal 131 receives the reply information from the client 132 (S708), and determines whether or not this information denotes that a virtual PVOL of the PVOL “3” is to be created (S709).

In a case where the result of the determination in S709 is negative (S709: No), the processing ends. This is because a virtual PVOL of the PVOL “3” will not be created, and, therefore, the PVOL attribute set and the SVOL attribute set will not become the same.

In a case where the result of the determination in S709 is affirmative (S709: Yes), the maintenance terminal 131 sends, to the storage apparatus 103, information signifying that a virtual PVOL of the PVOL “3” is to be created.

The virtualization control program 305 receives this information, refers to the LDEV management table 303, and sends the maintenance terminal 131 information denoting the information 411 through 413 corresponding to the SVOL “13”, which is the VOL that is not being virtualized.

The maintenance terminal 131 receives this information, and sends the client 132 display information for a virtual PVOL creation screen (S711). As shown in FIG. 8B, this creation screen, for example, is the screen 810, which comprises a query as to whether the virtual PVOL of the PVOL “3” is to be created automatically or manually, and VOL attribute options in a case where the virtual PVOL is to be created manually. The one or more VOL attribute options displayed in the screen 810 is information (the information received from the storage apparatus 103) denoting the information 411 through 413 corresponding to the SVOL “13”.

The client 132 displays the display information sent in S711 (S712). In accordance with this, for example, the screen 810 shown in FIG. 8B is displayed on the display device of the client 132. The client 132 receives the reply to the query (and a reply comprising the user-desired option specification) from the client 132 input device, and sends information denoting this reply (reply information).

The maintenance terminal 131 receives the reply information from the client 132 (S713), and sends this reply information to the storage apparatus 103 (S714).

The virtualization control program 305 creates a virtual PVOL of the PVOL “3” in accordance with this reply information (S715).

Thereafter, S716 through S719 are carried out.

According to the flow of processing shown in FIG. 7, a virtual VOL is created only in a case where the user desires to create a virtual VOL. Furthermore, a choice of whether to create the virtual VOL manually or automatically is also possible. Furthermore, in this example, whether a virtual VOL is to be created manually or automatically may be set beforehand. In a case where the automatic creation of a virtual VOL has been set, the flow of processing shown in FIG. 5 may be performed.

### EXAMPLE 3

In a third example, a VOL pair is created beforehand prior to a copy instruction. For example, the maintenance terminal 131 sends, to the storage apparatus 103, a pair create instruction comprising the PVOL # and the SVOL #. It will be supposed here that the PVOL # is “3” and that the SVOL # is “13”.

The virtualization control program 305, based on the LDEV management table 303, determines whether or not the VOL attribute sets of the PVOL “3” and the SVOL “13 specified in the pair create instruction are the same.

In a case where the result of this determination is affirmative, the virtualization control program 305 creates either a virtual PVOL of the PVOL “3” or a virtual SVOL of the SVOL “13”, and updates the virtualization management table 301.

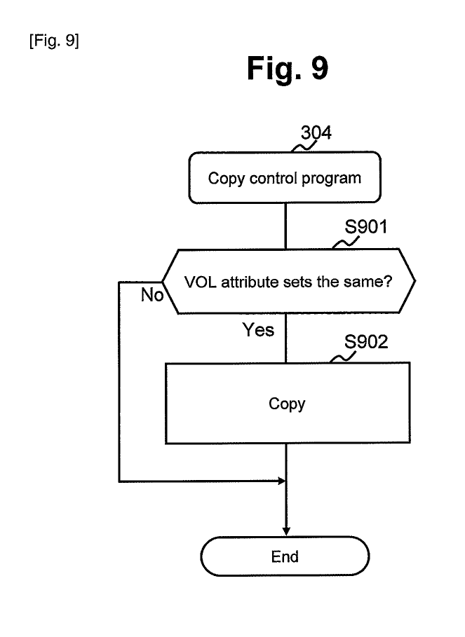

Thereafter, the copy control program 304, upon receiving a copy instruction, carries out the processing shown in FIG. 9. Furthermore, in the explanation of FIG. 9, it will be supposed that the PVOL and the SVOL specified in the copy instruction are also PVOL “3” and SVOL “13”. In the copy instruction, a pair # may be specified instead of the PVOL # and the SVOL #.

FIG. 9 shows the flow of processing carried out by the copy control program 304 related to the third example.

The copy control program 304 determines whether or not the VOL attribute set of the PVOL “3” is the same as the VOL attribute set of the SVOL “13” (S901). In the case of a virtual PVOL of the PVOL “3”, in S901 the copy control program 304 determines whether or not the VOL attribute set of this virtual PVOL is the same as the VOL attribute set of the SVOL “13”. Or, in the case of a virtual SVOL of the SVOL “13”, in S901 the copy control program 304 determines whether or not the VOL attribute set of this virtual SVOL is the same as the VOL attribute set of the PVOL “3”. The copy control program 304 may identify whether it is to be a virtual PVOL of the PVOL “3” or a virtual SVOL of the SVOL “13”, for example, by referring to the virtualization management table 301, or may have the virtualization control program 305 make a determination as to whether it is to be a virtual PVOL of the PVOL “3” or a virtual SVOL of the SVOL “13”.

In a case where the result of the determination in S901 is negative (S901: No), the copy control program 304 ends the processing. That is, a data copy between VOLs is not performed.

In a case where the result of the determination in S901 is affirmative (S901: Yes), the copy control program 304 carries out a data copy between VOLs (S902). In S902, the copy control program 304 may query the virtualization control program 305 as to the copy-source area address or the copy-destination area address in a case where the copy source is the virtual PVOL of the PVOL “3” or the copy destination is the virtual SVOL of the SVOL “13”. Specifically, for example, in a data copy to the SVOL “13” from the virtual PVOL of the PVOL “3”, the copy control program 304 inputs the original address of the copy-source area to the virtualization control program 305. The virtualization control program 305 converts the inputted original address and outputs the post-conversion address to the copy control program 304. Specifically, for example, the virtualization control program 305 determines an address based on the inputted original address, and differences between the PVOL “3” data arrangement attribute (for example, the emulation type) and the virtual PVOL data arrangement attribute, and outputs the determined address to the copy control program 304. The copy control program 304 reads data from the copy-source area (an area in the PVOL “3”) in accordance with the outputted address, and writes the read data to the copy-destination area (an area in the SVOL “13”) in accordance with an address that is the same as the original address.

### EXAMPLE 3

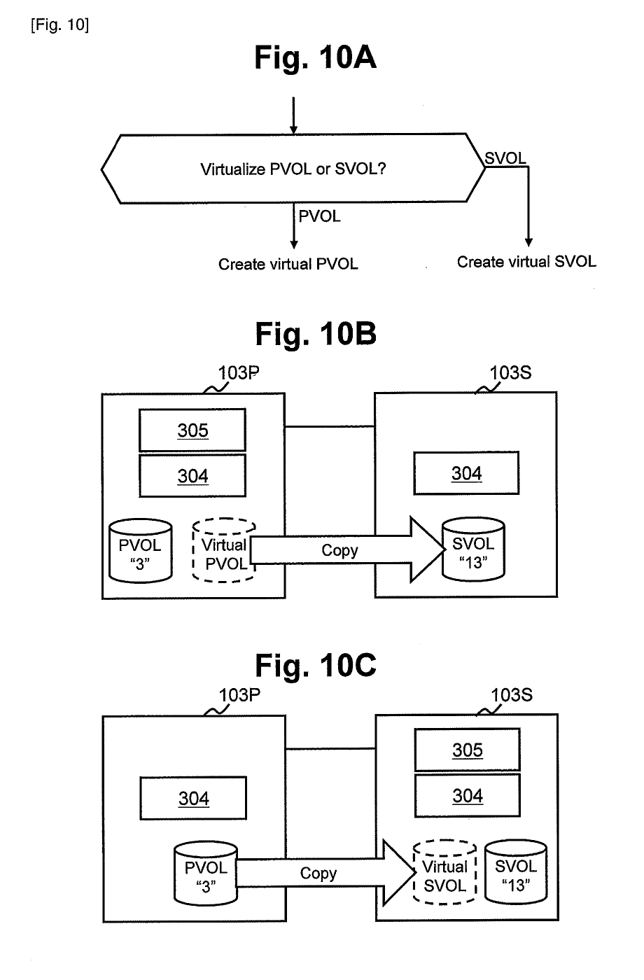

In a fourth example, as shown in FIG. 10A, a determination is made as to which of the PVOL or the SVOL is to be virtualized when creating the virtual VOL.

For example, as shown in FIG. 10B, in a case where there is a virtualization control program 305 in the storage apparatus 103P comprising the PVOL, but there is no virtualization control program 305 in the storage apparatus 103S comprising the SVOL, a virtual PVOL obtained by virtualizing the PVOL is created.

Alternatively, as shown in FIG. 10C, in a case where there is no virtualization control program 305 in the storage apparatus 103P comprising the PVOL, but there is a virtualization control program 305 in the storage apparatus 103S comprising the SVOL, a virtual SVOL obtained by virtualizing the SVOL is created.

The maintenance terminal 131 is able to determine whether the virtualization control program 305 is in the storage apparatus 103P or 103S. For example, the maintenance terminal 131 issues a predetermined query to both of the storage apparatuses 103P and 103S, and based on the response or lack of response to this query (or the contents of the response), is able to determine whether the virtualization control program 305 is in storage apparatus 103P or 103S. Or, the maintenance terminal 131 can store in advance information (for example, information denoting the model of each storage apparatus) related to the type of storage apparatus in which the virtualization control program 305 resides, and based on this information, can make a determination as to whether the virtualization control program 305 is in storage apparatus 103P or 103S.

In a case where it has been determined that the virtualization control program 305 is in the storage apparatus 103P but not in the storage apparatus 103S, the maintenance terminal 131 can send, to the storage apparatus 103P, a request to virtualize the PVOL. Alternatively, in a case where it has been determined that the virtualization control program 305 is in the storage apparatus 103S but not in the storage apparatus 103P, the maintenance terminal 131 can send, to the storage apparatus 1035, a request to virtualize the SVOL.

Furthermore, as criteria for determining which of the PVOL or the SVOL is to be virtualized, in addition to the above-described determination criteria, at least one of the following determination criteria may be used:

(1) whether the user has specified which of the PVOL or the SVOL is to be virtualized; and

(2) whether the PVOL attribute set is better than the SVOL attribute set or the SVOL attribute set is better than the PVOL attribute set.

A first VOL attribute set is better than a second VOL attribute set signifies that the first VOL attribute set comprises more good VOL attributes than the second VOL attribute set as was described in the explanation of FIG. 1. A “good VOL attribute” is a VOL attribute that conforms to either a new model (a storage apparatus model) or a new function (for example, an upgraded computer program in the storage apparatus).

The preceding has been explanations of a number of examples of the present invention, but the present invention is not limited to these examples, and, needless to say, a variety of changes can be made without departing from the gist thereof.

### REFERENCE SIGNS LIST

201 Storage system

211 Copy control part

215 Virtualization control part

1. A storage system comprising:
one or more storage control apparatuses comprising a PVOL which is a copy-source logical volume (VOL), and a SVOL which is a copy-destination VOL; and
a management computer, which is coupled to at least one of the one or more storage control apparatuses,
wherein at least one of the one or more storage control apparatuses comprises:
a copy control part determining whether or not a PVOL attribute set and a SVOL attribute set are the same, and carrying out a data copy between VOLs in a case where the result of this determination is affirmative; and
a virtualization control part,
wherein the PVOL attribute set is a VOL attribute set of the PVOL, which is a copy-source logical volume (VOL),
the SVOL attribute set is a VOL attribute set of the SVOL, which is a copy-destination VOL,
the VOL attribute set comprises one or more VOL attributes, which are compared at the time of the determination, and
the virtualization control part creates either a virtual PVOL which is a VOL obtained by virtualizing the PVOL and which comprises the SVOL attribute set, or a virtual SVOL which is a VOL obtained by virtualizing the SVOL and which comprises the PVOL attribute set,
thereby either the VOL attribute set of the virtual PVOL becomes the same as the SVOL attribute set, or the PVOL attribute set becomes the same as the VOL attribute set of the virtual SVOL, and the copy control part either copies data from the virtual PVOL to the SVOL or copies data from the PVOL to the virtual SVOL.

2. A storage system according to claim 1, wherein the PVOL attribute set and the SVOL attribute set comprise a data arrangement attribute,
which is a VOL attribute related to the arrangement of data inside a VOL,
data is copied from a copy-source area to a copy-destination area in the data copy,
an address of the copy-source area and an address of the copy-destination area are the same in the data copy according to a logic of the copy control part,
in a data copy from the virtual PVOL to the SVOL:
(a1) the virtualization control part determines an address of the copy-source area in the PVOL based on an address of the copy-source area in the virtual PVOL, and a difference between a data arrangement attribute of the virtual PVOL and a data arrangement attribute of the PVOL; and
(a2) data is copied from an area which conforms to this determined address and is the copy-source area in the PVOL, to an area which conforms to an address that is the same as the address of the virtual copy-source area and is the copy-destination area in the SVOL, and in a data copy from the PVOL to the virtual SVOL:
(b1) the virtualization control part determines an address of the copy-destination area in the SVOL based on an address of the copy-destination area in the virtual SVOL, and a difference between a data arrangement attribute of the virtual SVOL and a data arrangement attribute of the SVOL; and
(b2) data is copied from the copy-source area in the PVOL, to an area which conforms to the determined address and is the copy-destination in the SVOL.

3. A storage system according to claim 2, wherein the data arrangement attribute denotes a type of format of a VOL, or whether or not a VOL is a single VOL configured by logically concatenated multiple VOLs.

4. A storage system according to claim 1, wherein the virtual PVOL is created in a case where a first condition is satisfied, and the virtual SVOL is created in a case where a second condition is satisfied.

5. A storage system according to claim 4, wherein the PVOL and the SVOL exist in different storage control apparatuses,
a case where the first condition is satisfied is a case in which the virtualization control part exists in the storage control apparatus comprising the PVOL but the virtualization control part does not exist in the storage control apparatus comprising the SVOL, and
a case where the second condition is satisfied is a case in which the virtualization control part does not exist in the storage control apparatus comprising the PVOL but the virtualization control part exists in the storage control apparatus comprising the SVOL.

6. A storage system according to claim 5, wherein the management computer checks whether or not the virtualization control part exists in the storage control apparatus comprising the PVOL and the storage control apparatus comprising the SVOL,
in a case where the first condition is satisfied as a result of this check, the management computer sends, to the storage control apparatus comprising the PVOL, a request to create the virtual PVOL, and in a case where the second condition is satisfied as a result of this check, the management computer sends, to the storage control apparatus comprising the SVOL, a request to create the virtual SVOL.

7. A storage system according to claim 6, wherein the management computer outputs a query as to whether or not to create a virtual VOL as either the virtual PVOL or the virtual SVOL, and carries out the check upon receiving an affirmative reply in response to the query.

8. A storage system according to claim 1, wherein the management computer outputs a query as to whether or not to create a virtual VOL as either the virtual PVOL or the virtual SVOL, and
the virtualization control part creates either the virtual PVOL or the virtual SVOL in a case where the management computer receives an affirmative reply in response to the query.

9. A storage system according to claim 1, wherein the management computer outputs a query as to whether to create a virtual VOL as either the virtual PVOL or the virtual SVOL manually or automatically, and upon receiving a reply to create the virtual VOL manually in response to the query, the management computer either outputs information denoting the SVOL attribute set as display information denoting a VOL attribute set that the virtual PVOL can comprise, or outputs information denoting the PVOL attribute set as display information denoting a VOL attribute set that the virtual SVOL can comprise.

10. A storage system according to claim 1, wherein, in a case where the copy control part has determined that the PVOL attribute set and the SVOL attribute set are different, the virtualization control part creates either the virtual PVOL or the virtual SVOL.

11. A storage system according to claim 1, wherein the copy control part:
(a) either determines whether or not the VOL attribute set of the virtual PVOL is the same as the SVOL attribute set, or determines whether or not the PVOL attribute set is the same as the VOL attribute set of the virtual SVOL; and
(b) either copies data from the virtual PVOL to the SVOL, or copies data from the PVOL to the virtual SVOL, in a case where the result of the determination in the (a) is affirmative.

12. A storage control method, which is carried out in a storage control apparatus comprising a copy control part which determines whether or not a PVOL attribute set and a SVOL attribute set are the same, and carries out a data copy between VOLs in a case where the result of this determination is affirmative,
the storage control method comprising the step of:
creating either a virtual PVOL which is a VOL obtained by virtualizing the PVOL and which comprises a SVOL attribute set, or a virtual SVOL which is a VOL obtained by virtualizing the SVOL and which comprises a PVOL attribute set, thereby either making a VOL attribute set of the virtual PVOL the same as the SVOL attribute set, or making the PVOL attribute set the same as a VOL attribute set of the virtual SVOL, and enabling the copy control part to either copy data from the virtual PVOL to the SVOL or copy data from the PVOL to the virtual SVOL,
wherein the PVOL attribute set is the VOL attribute set of the PVOL, which is a copy-source logical volume (VOL),
the SVOL attribute set is the VOL attribute set of the SVOL, which is a copy-destination VOL, and
the VOL attribute set comprises one or more VOL attributes, which are compared at the time of the determination.

13. A storage control apparatus comprising:
a copy control part determining whether or not a PVOL attribute set and a SVOL attribute set are the same, and carrying out data copy between VOLs in a case where the result of this determination is affirmative; and
a virtualization control part,
wherein the PVOL attribute set is a VOL attribute set of the PVOL, which is a copy-source logical volume (VOL),
the SVOL attribute set is a VOL attribute set of the SVOL, which is a copy-destination VOL,
the VOL attribute set comprises one or more VOL attributes, which are compared at the time of the determination, and
the virtualization control part creates either a virtual PVOL which is a VOL obtained by virtualizing the PVOL and which comprises the SVOL attribute set, or a virtual SVOL which is a VOL obtained by virtualizing the SVOL and which comprises the PVOL attribute set,
thereby either the VOL attribute set of the virtual PVOL becomes the same as the SVOL attribute set, or the PVOL attribute set becomes the same as the VOL attribute set of the virtual SVOL, as a result of which, the copy control part either can copy data from the virtual PVOL to the SVOL or can copy data from the PVOL to the virtual SVOL.

14. A storage control apparatus according to claim 13, wherein the PVOL attribute set and the SVOL attribute set comprise a data arrangement attribute, which is a VOL attribute related to the arrangement of data inside a VOL,
data is copied from a copy-source area to a copy-destination area in the data copy,
an address of the copy-source area and an address of the copy-destination area are the same in the data copy according to a logic of the copy control part,
in a data copy from the virtual PVOL to the SVOL, the virtualization control part determines an address of the copy-source area in the PVOL based on an address of the copy-source area in the virtual PVOL, and a difference between a data arrangement attribute of the virtual PVOL and a data arrangement attribute of the PVOL, and data is copied from an area which conforms to this determined address and is the copy-source area in the PVOL, to an area which conforms to an address that is the same as the address of the virtual copy-source area and is the copy-destination area in the SVOL, and
in a data copy from the PVOL to the virtual SVOL, the virtualization control part determines an address of the copy-destination area in the SVOL based on an address of the copy-destination area in the virtual SVOL, and a difference between a data arrangement attribute of the virtual SVOL and a data arrangement attribute of the SVOL, and data is copied from the copy-source area in the PVOL, to an area which conforms to the determined address and is the copy-destination in the SVOL.
